(19) United States
(12) Patent Application Publication
(10) Pub. No.: US 2010/0249961 A1
(43) Pub. Date: Sep. 30, 2010

(54) Environmental sound reproducing device

(75) Inventors: Hiroaki Yamane, Saitama (JP); Masato Nonaka, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/656,443

(22) Filed: Jan. 29, 2010

(30) Foreign Application Priority Data
Mar. 30, 2009 (JP) 2009-082750

(51) Int. Cl. G06F 17/00

(52) U.S. Cl. 700/94

(57) ABSTRACT

An environmental sound reproducing device which can appropriately transfer a state of a target in a remote area from that remote area to a desired destination is provided. This sound reproducing device includes a communication unit that receives state information indicating a state of a detection target from an external detector. The environmental sound reproducing device also includes a database that stores in advance one or more environmental sound data corresponding to one or more states of the detection target. The environmental sound reproducing device also includes a selector that selects, based on the state information, most appropriate one of the environmental sound data from the database. The environmental sound reproducing device also includes a sound reproducing unit that reproduces the selected environmental sound data (creates a sound represented by the selected environmental sound data). The environmental sound data which have been prepared in advance is reproduced, in place of an actual sound, based on the state information supplied from the detection device. The environmental sound data does not contain noise, a disturbing sound, unpleasant sound or the like. Hence, unnecessary sounds such as noise are not transmitted to a user. The state of the detection target can be transferred more appropriately than the case of transmitting the actual sound.

### BACKGROUND OF THE INVENTION

1. Field of the Invention

The present invention relates to an environmental sound reproducing device, an environmental sound reproducing system, an environmental sound reproducing method, and a program.

2. Description of the Related Art

In order to transfer atmosphere and live feeling of a spot in a remote area from that remote area to a desired destination, one at the sending side tries to capture real or actual environmental sounds that represent the state of that remote spot. For example, Japanese Patent Application Kokai (Laid-Open) No. 8-214392 discloses a headset to transmit environment sounds that represent the ambient state of the headset user in a remote area in real-time. This headset transmits the live feeling of the spot by transmitting the actual sounds around the headset user that are captured through a microphone as environmental sounds together with headset user's conversing voices using a voice communication system such as VoIP (Voice Over Internet Protocol).

### SUMMARY OF THE INVENTION

If an actual sound that is simply captured by a microphone is transmitted as an environmental sound, the state of the spot in the remote area may not be transferred accurately. For example, when an operating sound of a keyboard is transmitted to transfer the keyboard operation state, noises generated around the keyboard are also transmitted, and the keyboard operation state is transferred with the noises (i.e., unnecessary sounds). If an actual open/close sound of a door is transmitted to transfer the open/close state of the door, a disturbing sound or unpleasant sound, which may or may not heard by human being, is also captured and transmitted, and therefore the open/close state of the door is transferred with the disturbing sound (unnecessary sound). If the sound of footsteps generated during moving (e.g., walking or running) should be transmitted to transfer the moving state of an individual, then the sound of footsteps sometimes is too quiet, and no sound is transferred (i.e., the moving state of an individual cannot be transferred accurately. For example, no sound is transferred even when he/she runs.

One object of the present invention is to provide an environmental sound reproducing device, with which the state of the spot in a remote area can be appropriately or accurately transferred.

Another object of the present invention is to provide an environmental sound reproducing system, with which the state of the spot in a remote area can be appropriately or accurately transferred.

Still another object of the present invention is to provide an environmental sound reproducing method, with which the state of the spot in a remote area can be appropriately or accurately transferred.

Yet another object of the present invention is to provide a program that causes a computer to appropriately or accurately transfer the state of the spot in a remote area to a destination.

According to a first aspect of the present invention, there is provided an improved environmental sound reproducing device. This environmental sound reproducing device includes a reception unit that receives state information indicating a state of a detection target from an external detection device. The environmental sound reproducing device also includes an environmental sound storage that stores one or more environmental sound data corresponding to one or more states of the detection target. The environmental sound reproducing device also includes an environmental sound selector that selects, based on the state information received from the detection device, one environmental sound data from the environmental sound storage. The environmental sound reproducing device also includes an environmental sound reproducing unit that reproduces a sound represented by the environmental sound data selected by the environmental sound selector.

The environmental sound reproducing device receives state information, which indicates a state of a detection target located in a remote area, from the external detection device, and selects environmental sound data corresponding to the state of the detection target from the environmental sound data storage based on the received state information. One or more environmental sound data is stored in the sound data storage in advance. Then, the environmental sound reproducing device reproduces a sound represented by the selected environmental sound data. A sound represented by the selected environmental sound data is reproduced instead of actual sound. The environmental sound data does not contain noise, disturbing sound, unpleasant sound or the like. Therefore, such unnecessary sounds are not transmitted to a user of the environmental sound reproducing device. In addition, if an actual sound is too quiet but the target is in fact moving, then the detection device can detect the movement of the target so that the environmental sound reproducing device makes a sound that expresses the movement of the target. In other words, regardless of the actual sound, the environmental sound reproducing device utters a sound that best expresses the target state or condition. Accordingly, the state of the detection target can be transferred to the device user more appropriately than the case of transmitting the actual sound. Furthermore, the quantity of the state information is smaller than the actual sound, so that the transmission load on the communication system can be decreased compared with the case of transmitting the actual sound.

The external detection device may detect a plurality of states of a plurality of detection targets, respectively. The reception unit may receive state information indicating the state of each detection target together with identification information identifying the detection target concerned, from the external detection device. The environmental sound selector may select, based on a combination of the state information and the identification information received from the detection device, one of the environmental sound data from the environmental sound data storage. Thus, the sound data selector selects a most appropriate sound data from the sound data storage based on the detected state of the target and the identification information. Accordingly, the single environmental sound reproducing device is able to deal with two or more targets.

The environmental sound storage may only store reference sound data that corresponds to a particular state of the detection target. The environmental sound selector always selects the reference sound data regardless of the detected state of the target. This reference sound data is processed with one of parameters that is decided by the state information sent from the detection device. Thus, the environmental sound reproducing device may further include an environmental sound processing unit that processes the reference environmental sound data such that the processed sound data becomes environmental sound data corresponding to the state of the detection target received from the detection device. The environmental sound reproducing unit may reproduce the environmental sound data processed by the environmental sound processing unit. Because the reference sound data is the only sound data stored in the sound data storage, the size of the sound data storage can be reduced. Various states of the detection target can be reproduced using the small amount of sound data.

The external detection device may include two or more sensors or detectors to detect two or more types of states of the detection target. The reception unit may receive state information indicating two or more types of states of the same detection target from these sensors/detectors. The two or more types of the target state may be combined to single state information. Then, the environmental sound selector may select one sound data from the environmental sound storage based on the state information. The state information represents two or more types of the states of the target, and an environmental sound data is selected and reproduced based on such state information. Therefore, a detailed state of the detection target can be reproduced.

The detection device may have a plurality of sensors/detectors to detect a plurality of states of a plurality of detection targets respectively. The reception unit may receive state information indicating the state of each detection target from the external detection device. The environmental sound reproducing unit may have a plurality of environmental sound reproducing modules that correspond to the detection targets respectively. The environmental sound selector may select one of the environmental sound data corresponding to the state of each of the detection targets from the environmental sound storage based on each of the state information received from the detection device. Each of the environmental sound reproducing modules may reproduce the selected environmental sound for the associated target. Therefore, sounds expressing the states of the detection targets may be reproduced from the associated sound reproducing modules respectively or simultaneously. The sound reproducing modules may be integrated in the single sound reproducing unit.

According to the second aspect of the present invention, there is provided an environmental sound reproducing system. The system includes a detection device, that can detect a state of a detection target, and an environmental sound reproducing device according to the first aspect of the present invention.

According to the third aspect of the present invention, there is provided an environmental sound reproducing method that includes receiving state information indicating the state of a detection target from an external detection device. The method also includes selecting one environmental sound data from the environmental sound data storage based on the state information received from the external detection device. One or more sound data is stored in advance in the environmental sound data storage. The method also includes reproducing a sound represented by the selected environmental sound data.

According to this method, the state information that indicates the detection target state is received from the external detection device, and the environmental sound data corresponding to the state of the detection target is selected from the environmental sound data storage, based on the received state information. Then, the sound represented by the selected environmental sound data is reproduced. Since the environmental sound data which are prepared in advance is reproduced instead of the actual sound, the state of the detection target can be transferred more appropriately compared with the case of transmitting the actual sound.

According to the fourth aspect of the present invention, there is provided a program for causing (or enabling) a computer to execute the environmental sound reproducing method according to the third aspect of the present invention.

Therefore, the present invention provides an environmental sound reproducing device, environmental sound reproducing system, environmental sound reproducing method, and program, that can transfer the state of a spot in a remote area appropriately.

These and other objects, aspects and advantages of the present invention will become more apparent to those skilled in the art from the following detailed description when read and understood in conjunction with the appended claims and drawings.

### BRIEF DESCRIPTION OF THE DRAWINGS

FIG. 1 illustrates an overview of an environmental sound reproducing system that is common to all or most of embodiments of the present invention;

FIG. 2 is a block diagram depicting a functional configuration of an environmental sound reproducing system according to a first embodiment of the present invention;

FIG. 3 is a block diagram depicting a modification to the environmental sound reproducing system shown in FIG. 2;

FIG. 4 is a sequence diagram depicting an operation of the environmental sound reproducing system according to the first embodiment using a door open/close sensor;

FIG. 5 is a sequence diagram depicting an operation of the environmental sound reproducing system according to the first embodiment using a moving speed sensor;

FIG. 6 is a block diagram depicting a functional configuration of an environmental sound reproducing system according to a second embodiment;

FIG. 7 is a sequence diagram depicting an operation of the environmental sound reproducing system according to the second embodiment;

FIG. 8 is a block diagram depicting a functional configuration of an environmental sound reproducing system according to a third embodiment;

FIG. 9 is a sequence diagram depicting an operation of the environmental sound reproducing system according to the third embodiment;

FIG. 10 is a block diagram depicting a functional configuration of an environmental sound reproducing system according to a fourth embodiment;

FIG. 11 is a sequence diagram depicting an operation of the environmental sound reproducing system according to the fourth embodiment;

FIG. 12 is a block diagram depicting a functional configuration of an environmental sound reproducing system according to a fifth embodiment;

FIG. 13 is a sequence diagram depicting an operation of the environmental sound reproducing system according to the fifth embodiment; and

FIG. 14 is a block diagram depicting an exemplary hardware configuration of the environmental sound reproducing device according to the embodiments of the present invention.

### DETAILED DESCRIPTION OF THE INVENTION

Embodiments of the present invention will now be described with reference to the accompanying drawings. In the following description and accompanying drawings, elements and parts having substantially a same function are denoted with same or similar reference symbols, for which redundant description is omitted.

### 1. Overview of Environmental Sound Reproducing System

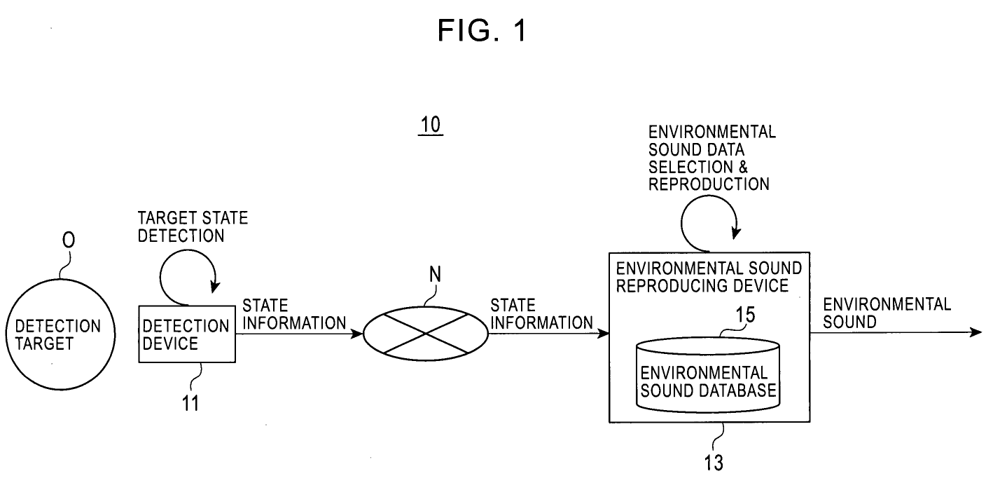

Referring to FIG. 1, a general idea of an environmental sound reproducing system 10 according to the present invention will be described. As FIG. 1 shows, the environmental sound reproducing system 10 has a detection device 11 and an environmental sound reproducing device 13. The environmental sound reproducing device 13 is connected to the detection device 11 via a communication network N. The communication network N is a cable and/or radio communication means that can connect the detection device 11 to the environmental sound reproducing device 13 unidirectionally or bidirectionally.

The detection device 11 detects a state of a detection target O and transmits the detected state of the target (referred to as “state information”) to the environmental sound reproducing device 13. The environmental sound reproducing device 13 has an environmental sound database 15 for storing a plurality of environmental sound data corresponding to various states of the detection target O. These environmental sound data are prepared in advance. Upon receiving the state information from the detection device 11, the environmental sound reproducing device 13 selects one sound data from the environmental sound database 15 that most matches the state of the detection target O based on the state information, and retrieves it as the environmental sound data. Then, the environmental sound reproducing device 13 creates or reproduces an environmental sound based on the environmental sound data and sends it to the outside (i.e., to a system user or a user of the environmental sound reproducing device 13). It should be noted that the state information may be detection data that indicates the detection result of the state of the detection target O, or may be a certain determination result obtained from the detection data.

A sound represented by the environmental sound data corresponding to the state information is reproduced (created) instead of actual sound. The environmental sound data does not contain noise, disturbing sound, unpleasant sound and other unnecessary sound, and therefore the environmental sound reproduced from the environmental sound data also contain no noise, disturbing sound, unpleasant sound and other unnecessary sound. Thus, noise, disturbing sound, unpleasant sound, low sound and the like are not transmitted to a system user (or a user of the sound reproducing device 130), and the state of the detection target O is transferred to the system user (or the user of the sound reproducing device 130) more appropriately than the case of transmitting the actual sound. Furthermore state information of which information volume is smaller than the actual sound is transmitted. Therefore, the transmission load on the communication system is decreased compared with the case of transmitting actual sound.

If an actual sound is too quiet but the target is in fact moving, then the environmental sound reproducing device can make an appropriate sound. This is because the detection device detects the movement of the target so that the environmental sound reproducing device makes a sound that expresses the movement of the target. In other words, regardless of the actual sound (even if the actual sound is very small), the environmental sound reproducing device utters a sound that best expresses the target state or condition. The loudness (or volume) of the sound issued from the environmental sound reproducing device has a value that can be perceived (or heard) by the user of the environmental sound reproducing device. Accordingly, the state of the detection target can be transferred to the device user more appropriately than the case of transmitting the actual sound.

### 2. First Embodiment

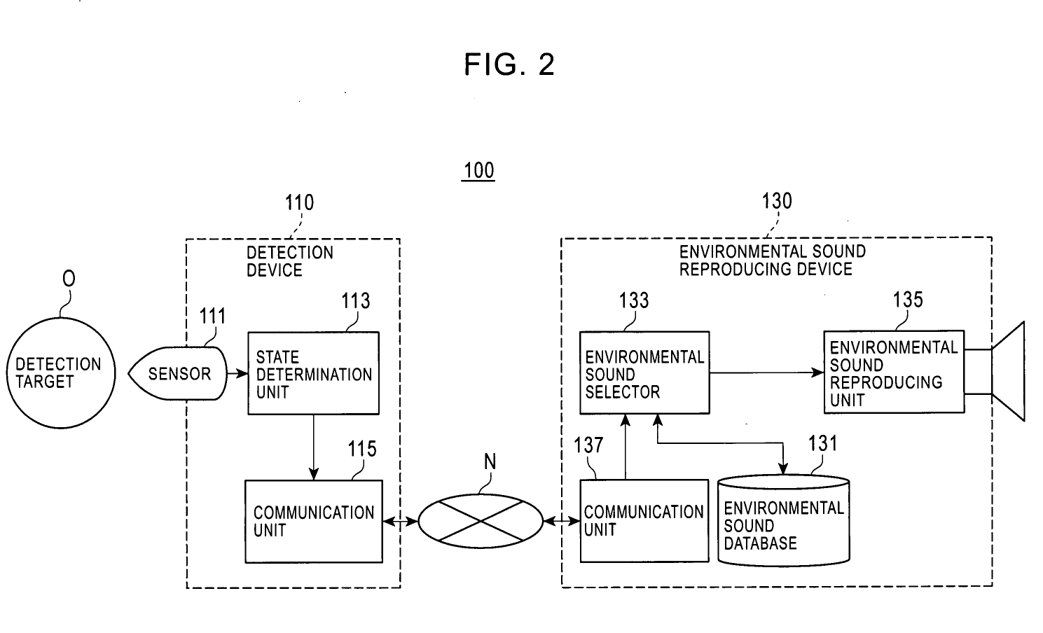

The environmental sound reproducing system 100 according to a first embodiment of the present invention will now be described with reference to FIG. 2 to FIG. 5.

### 2.1 Functional Configuration of Environmental Sound Reproducing System 100

FIG. 2 is a block diagram depicting a functional configuration of the environmental sound reproducing system 100 according to the first embodiment. As FIG. 2 shows, the environmental sound reproducing system 100 has a single detection device 110 and an environmental sound reproducing device 130. Hereafter, a case of reproducing (creating) a sound from environmental sound data that best matches an open/close state of a door or a moving state of an individual is described.

The detection device 110 includes a sensor unit 111, state determination unit 113 and communication unit 115. These composing elements 111, 113 and 115 of the detection device 110 are integrated in the illustrated embodiment, but one or more composing elements of the detection device 110 may be installed as separate unit(s) that can be connected by wire or wireless using a suitable communication device or technology.

The sensor unit 111 detects a state of a detection target O. The detection target O may be an object, such as a door or an individual, or may be a non-object, such as the weather and temperature. The sensor unit 111 is a door open/close sensor that detects the open/close state of the door or a moving speed sensor that detects the moving state of an individual using a position detection system, for example. The sensor 111 supplies detection data “open” or “close” that indicates the open/close state of the door, or detection data “0 km/h”, “4 km/h” or the like of the moving state (moving speed) of an individual, to the state determination unit 113. The state of the detection target O is expressed by an analog or digital data value, and/or the change of the data value, for example.

The state determination unit 113 determines the state of the detection target O based on the detection data. The state determination unit 113 generates the determination result “door open” or “door close” based on the detection data “open” or “close” to indicate the open/close state of the door, for example. The state determination unit 113 generates the determination result “individual stopping,” “individual walking” or “individual running” based on the detection data with predetermined conditions. The conditions are, for example, “less than 2 km/h,” “between 2 km/h and 8 km/h,” and “over 8 km/h.” If the detection data is 1 km/h, for example, then the determination unit 113 determines (considers) that the target person stops and generates the determination result “individual stopping.” If the detection data is 4 km/h, then the determination unit 113 determines that the target person is walking and generates the determination result “individual walking.”If the detection data is 15 km/h, then the state determination unit 113 generates the determination result “individual running.” The state of the detection target O may be determined by comparing the detection data that is obtained from the sensor unit 111 with determination conditions of the detection target O that are managed by the state determination unit 113.

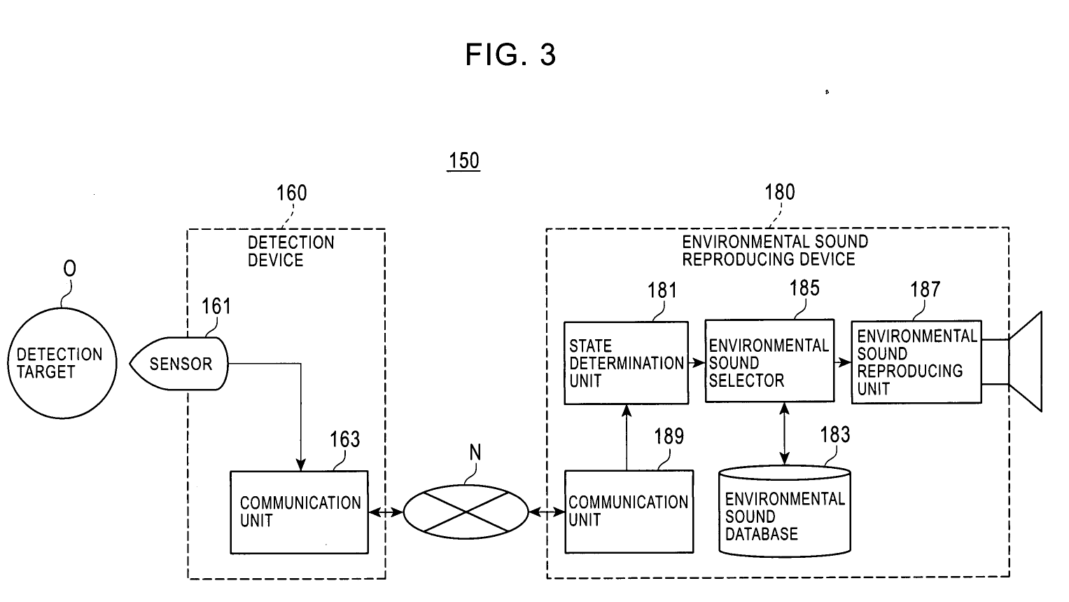

The communication unit 115 transmits the determination result regarding the detection target state to the environmental sound reproducing device 130. The communication unit 115 sends the determination result (or the detection data; in the case of the modified embodiment shown in FIG. 3) to the environmental sound reproducing device 130.

The environmental sound reproducing device 130 includes an environmental sound database 131, environmental sound selector 133, environmental sound reproducing unit 135, and communication unit 137. These composing elements 131, 133, 135, 137 of the environmental sound reproducing device 130 are integrated in a single device (i.e., device 130) in the illustrated embodiment, but one or more of these composing elements of the environmental sound reproducing device 130 may be installed as separate units that can be connected by wire or wireless using a suitable communication device or technology.

The environmental sound database 131 stores a plurality of environmental sound data corresponding to various states of the detection target O (or various determination results of the detection target O). The environmental sound data is sound data that represents open/close sound of the door or the walking sound of an individual, for example. The environmental sound database 131 stores the environmental sound data “door open” and “door close” in association with the open state and close state of the door respectively. The environmental sound database 131 stores the environmental sound data “individual stopping,” “individual walking” and “individual running” in association with the stopping state, walking state and running state of an individual respectively.

The environmental sound selection unit 133 selects one environmental sound data corresponding to the state of the detection target O from the environmental sound database 131 based on the determination result received from the detection device 110. When the determination result “door open” or “door close” is received, the environmental sound selection unit 133 selects the environmental sound data “door open” or “door close.” The environmental sound selection unit 133 supplies the selected environmental sound data to the environmental sound reproducing unit 135. If the environmental sound data need not be reproduced, such as the case of receiving “individual stopping,” for example, the environmental sound selection unit 133 need not select or supply the environmental sound data. This is the case where the state of the detection target should be expressed by silence.

The environmental sound reproducing unit 135 reproduces a sound that is represented by the environmental sound data supplied from the environmental sound selection unit 133 (i.e., artificial environmental sound is created instead of an actual sound), and outputs the (artificial) environmental sound to the outside. The environmental sound reproducing unit 135 has an environmental sound reproducing function and outputting function in the illustrated embodiment, but any suitable environmental sound output device, such as a speaker, may be installed as a separate component that can be connected to the device 130 (or 135) by wire or wireless using a suitable communication device or technology.

The communication unit 137 receives the determination result on the state of the detection target O from the detection device 110.

FIG. 3 is a block diagram depicting a modification to the environmental sound reproducing system 100 shown in FIG. 2. As FIG. 3 shows, a state determination unit 181 may be disposed not in a detection device 160 but in an environmental sound reproducing device 180. In this configuration, a communication unit 163 of the detection device 160 sends detection data indicating a state of the detection target O to the environmental sound reproducing device 180, and a communication unit 189 of the environmental sound reproducing device 180 receives the detection data from the detection device 160. The state determination unit 181 of the environmental sound reproducing device 180 determines the state of the detection target O based on the detection data, and supplies the determination result on the detection target state to an environmental sound selection unit 185.

Each of the composing elements of the detection device 110 or 160 and the environmental sound regeneration device 130 or 180 may be a standard element or circuit, or may be implemented by hardware, software or combination of hardware and software designed for executing the specific function of the composing element concerned. At least part of the functions of one or more of the composing elements may be implemented by programs that are executed by any suitable computer or computing device.

### 2.2 Operation of Environmental Sound Reproducing System 100

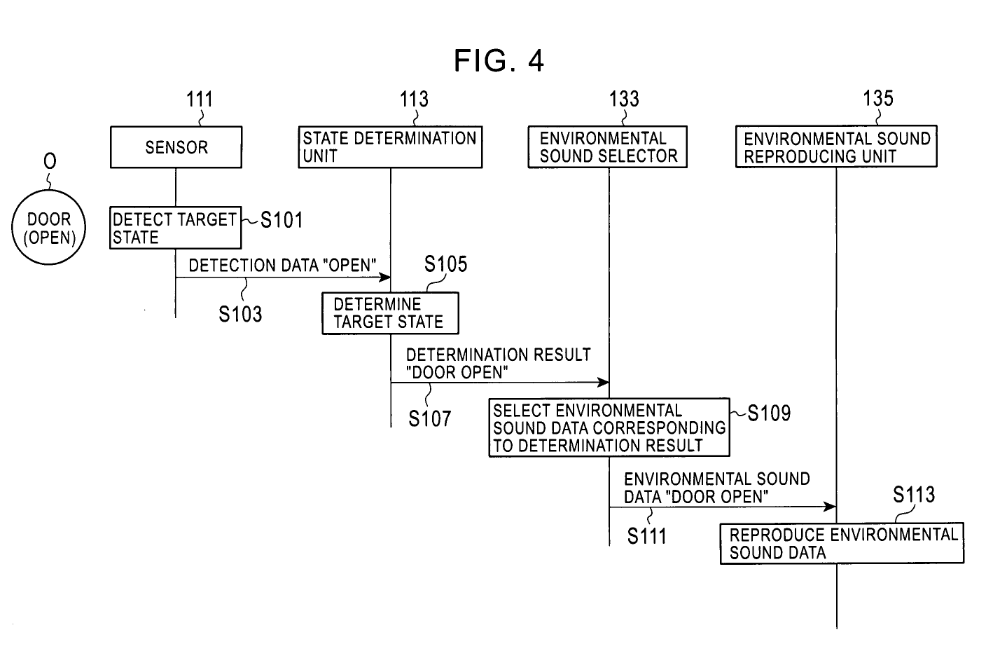

FIG. 4 is a sequence diagram depicting an operation of the environmental sound reproducing system 100 according to the first embodiment, using a door open/close sensor.

As FIG. 4 shows, when the door, that is the detection target O, is opened, the sensor 111, that is the door open/close sensor, detects the open state of the door (step S101), and supplies the detection data “open,” which indicates the open state of the door, to the state determination unit 113 (S103). The state determination unit 113 determines the open/close state of the door based on the detection data “open” (S105), and generates the determination result “door open.” The communication unit 115 transmits the determination result “door open” to the environmental sound reproducing device 130 (S107).

The environmental sound selector 133 selects the environmental sound data “door open” from the environmental sound database 131 based on the determination result “door open” (S109), and supplies it to the environmental sound reproducing unit 135 (S111). The environmental sound reproducing unit 135 reproduces (creates) a sound represented by the environmental sound data “door open” (S113), and outputs the resulting sound to the outside (to a user of the system 100 or a user of the device 130). Thus, the open/close state of the door, that is the detection target O, can be appropriately transferred to the user of the environmental sound reproducing system 100.

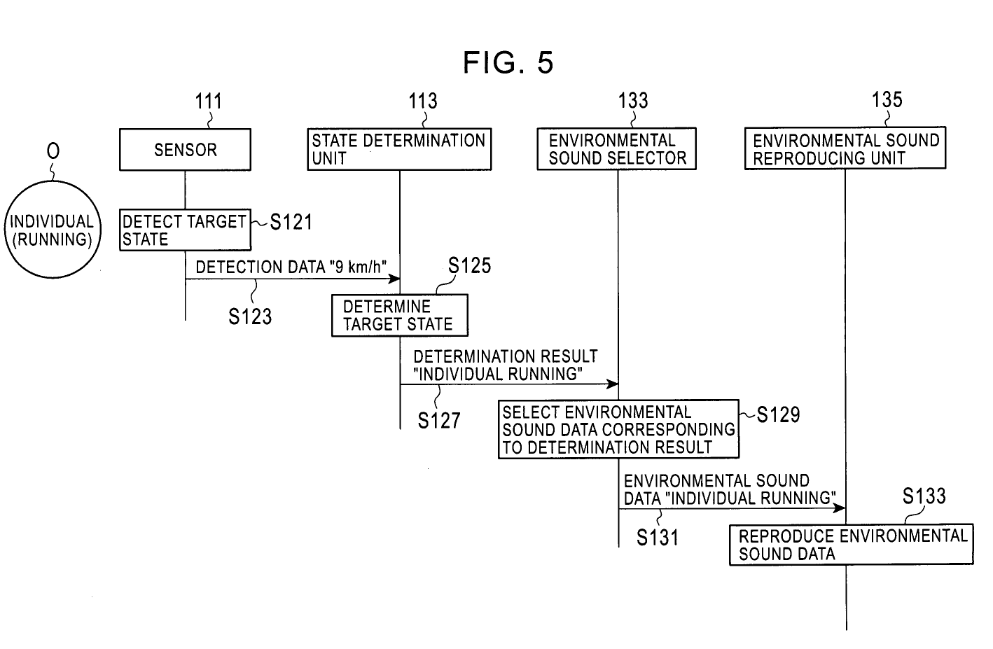

FIG. 5 is a sequence diagram depicting an operation of the environmental sound reproducing system 100 according to the first embodiment, using a moving speed sensor.

As FIG. 5 shows, when the moving of an individual at 9 km/h, that is a detection target O, is detected, the sensor unit 111, that is the moving speed sensor, detects the moving speed of the individual (S121), and supplies the detection data “9 km/h” which indicates the moving state of the individual to the state determination unit 113 (S123). The state determination unit 113 determines the moving state of the individual based on the detection data “9 km/h” (S125), and generates the determination result “individual running.” The communication unit 115 transmits the determination result “individual running” to the environmental sound reproducing device 130 (S127).

The environmental sound selection unit 133 selects the environmental sound data “individual running” from the environmental sound database 131 based on the determination result “individual running” (S129), and supplies it to the environmental sound reproducing unit 135 (S131). The environmental sound reproducing unit 135 reproduces a sound represented by the environmental sound data “individual running” (S133), and outputs the environmental sound indicating the running state of the individual to the outside. Thus, the moving state of the individual, that is the detection target O, can be appropriately transferred to the user of the environmental sound reproducing system 100.

As described above, the environmental sound reproducing system 100 of the first embodiment can provide (utter) a sound corresponding to the target state instead of actual sound. Therefore, noise, disturbing sound, unpleasant sound (e.g., low frequency sound or high frequency sound) and the like are not transmitted. In addition, if an actual sound is too quiet but the target is in fact moving, then the detection device can detect the movement of the target so that the environmental sound reproducing device makes a sound that expresses the movement of the target. In other words, regardless of the actual sound, the environmental sound reproducing device utters a sound that best expresses the target state or condition. Therefore, the state or condition of the detection target O can be transferred to the system user more appropriately than the case of transmitting the actual sound. Furthermore a quantity of the state information is smaller than the actual sound. Thus, the transmission load on the communication system can be decreased compared with the case of transmitting actual sound.

It should be noted that the detection target O is not limited to the door. For example, the detection target may be weather, and the sensor 111 may be a weather sensor. If it rains, the sensor 111 may detect the raining, and the environmental sound reproducing device 130 may reproduce the sound of rain.

### 3. Second Embodiment

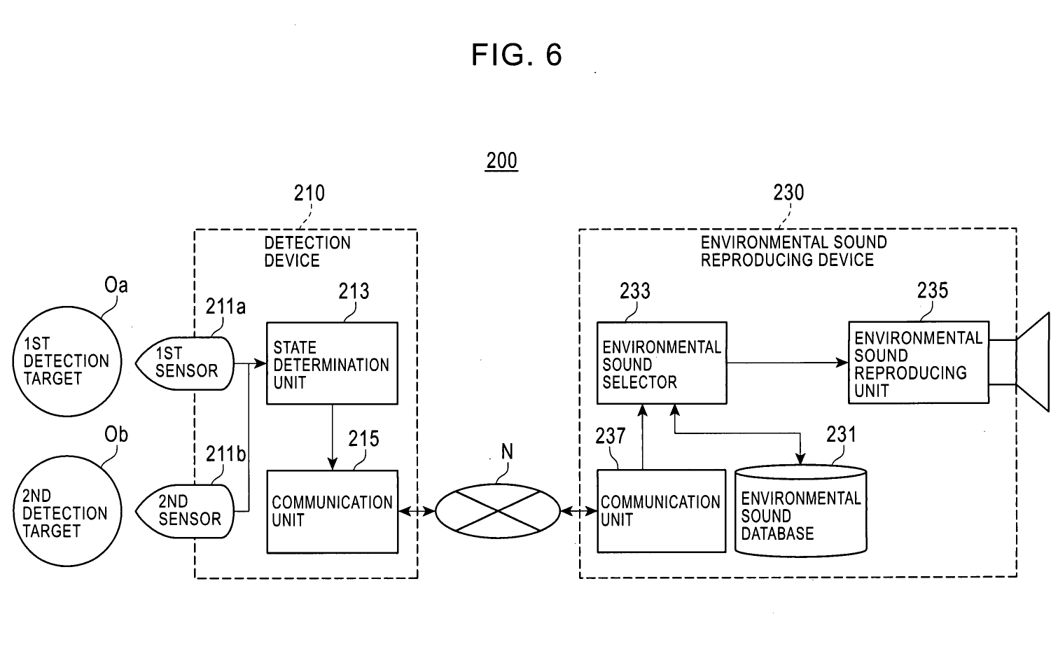

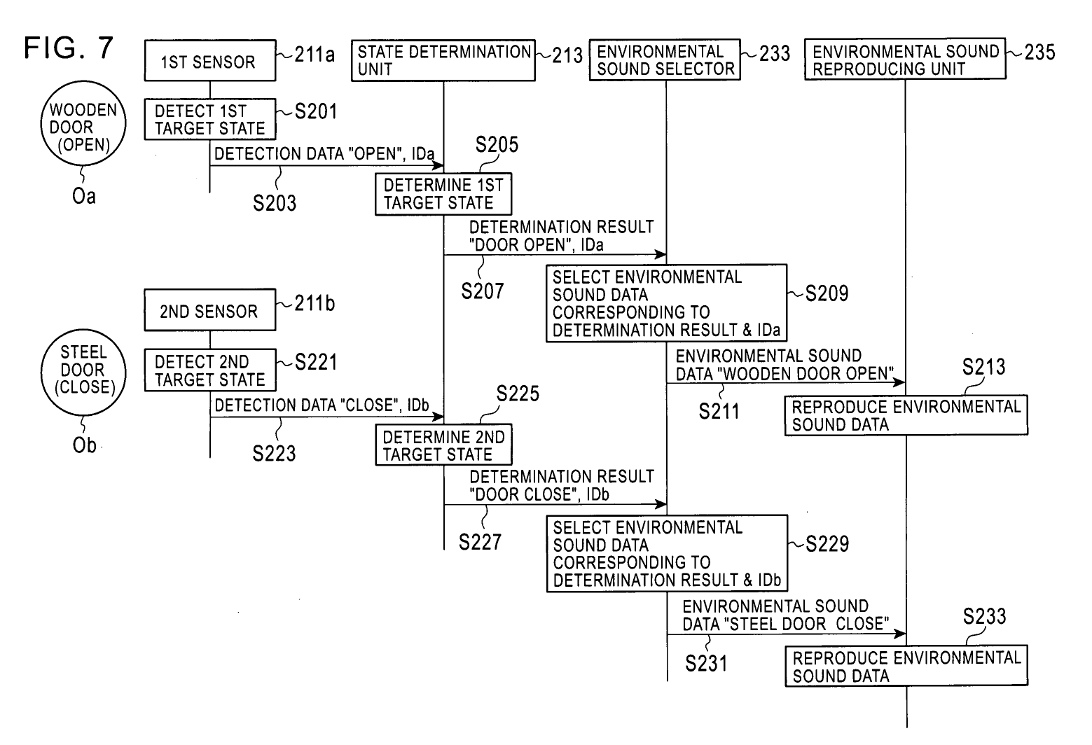

An environmental sound reproducing system 200 according to a second embodiment of the present invention will now be described with reference to FIG. 6 and FIG. 7. The second embodiment has similar aspects and features to the first embodiment, and therefore redundant description mutual to both the embodiments is omitted in the following description.

It should be recalled that the environmental sound reproducing system 100 according to the first embodiment is designed to transfer the state of a single detection target O. Therefore if the states of two or more detection targets Oa, Ob, . . . , such as a wooden door and steel door, or a door and a window, are transferred to the user of the environmental sound reproducing device 130, the environmental sound reproducing device 130 must be provided for each of the detection targets Oa, Ob, . . . . The environmental sound reproducing system 200 according to the second embodiment is for useful transferring to a system user the states of two or more detection targets Oa, Ob, . . . using a single environmental sound reproducing device 230.

### 3.1 Functional Configuration of Environmental Sound Reproducing System 200

FIG. 6 is a block diagram depicting a functional configuration of the environmental sound reproducing system 200 according to the second embodiment. As FIG. 6 shows, the environmental sound reproducing system 200 has a detection device 210 that includes two sensors 211a, 211b and an environmental sound reproducing device 230. Hereafter a case of reproducing a sound corresponding to environmental sound data representing open/close state of a wooden door or a steel door is described. It should be noted that although two sensors 211a and 211b are illustrated and described, three or more sensors may be provided depending upon the number of targets.

The two sensors 211a and 211b detect the states of two detection targets Oa and Ob respectively. The sensors 211a and 211b are assigned identification information IDa and IDb respectively. Each of the sensors 211a and 211b is a door open/close sensor. The first sensor 211a detects the open/close state of the wooden door Oa, and the second sensor 211b detects open/close state of the steel door Ob. The sensor 211a/211b supplies the detection data “open” or “close” that indicates the open/close state of the door concerned, along with the identification information Ida/IDb, to a state determination unit 213. The identification information IDa/IDb uniquely specifies the sensor unit 211a/211b and the detection target Oa/Ob. In the illustrated embodiment, the identification information IDa specifies the first sensor unit 211a and the detection target Oa. The two sensors 211a and 211b may send the detection data simultaneously to the state determination unit 213. In such a case, the determination unit 213 may give a priority to the detection data supplied from the second sensor 211b. If only the first sensor 211a detects the open/close state of the door Oa (i.e., the door Ob is still), the detection data is supplied to the determination unit 213 from the first sensor 211a only. If only the second sensor 211b detects the open/close state of the door Ob (i.e., the door Oa is still), the detection data is supplied to the determination unit 213 from the second sensor 211b only.

The state determination unit 213 determines the state of each detection target Oa, Ob based on the detection data of the associated sensor unit 211a, 211b. The state determination unit 213 generates the determination result “door open” or “door close” based on the detection data “open” or “close” respectively. As mentioned earlier, when the state determination unit 213 receives the detection data from the two sensors 211a and 211b simultaneously, the state determination unit 213 gives a priority to the detection data from the second sensor 211b. In such case, therefore, the state determination unit 213 generates the determination result for the detection data supplied from the second sensor 211b.

A communication unit 215 associates the determination result of the open/close state of the wooden door or the steel door with the identification information of the sensor 211a or 211b, and sends the determination result and the identification information to the environmental sound reproducing device 230.

An environmental sound database 231 has stored in advance various environmental sound data representing various states of each detection target Oa, Ob (or sound data corresponding to various determination results of each detection target Oa, Ob). The environmental sound data is sound data that represents or expresses the open/close sound of the wooden door and the open/close sound of the steel door. The environmental sound database 231 stores the environmental sound data “wooden door open,” “wooden door close,” “steel door open” and “steel door close,” for example, in association with the open/close state of the wooden door and the steel door respectively.

An environmental sound selector 233 selects environmental sound data for each detection target Oa, Ob based on the combination of the determination result and the identification information supplied from the detection device 210. The environmental sound selection unit 233 has a selection table which is set in advance so as to associate the combination of the determination result and the identification information with the environmental sound data. The selection table associates the combination of the determination result “door open” and identification information IDa (wooden door) with the environmental sound data “wooden door open,” and associates the combination of the determination result “door close” and the identification information IDb (steel door) with the environmental sound data “steel door close,” for example. If the determination result “door open” and the identification information IDa are received, the environmental sound selection unit 233 refers to the selection table and selects the environmental sound data “wooden door open.” If the determination result “door close” and identification information IDb are received, the environmental sound selection unit 233 refers to the selection table and selects the environmental sound data “steel door close.”

A communication unit 237 receives the state determination result of the wooden door or the steel door, and the identification information of the sensor unit 211a or 211b from the detection device 210.

### 3.2 Operation of Environmental Sound Reproducing System 200

FIG. 7 is a sequence diagram depicting an operation of the environmental sound reproducing system 200 according to the second embodiment.

As FIG. 7 shows, when the wooden door, that is the first detection target Oa, is opened, the first sensor unit 211a detects the open state of the wooden door (S201), and supplies the detection data “open” that indicates the open state of the door and the identification IDa of the first sensor unit 211a to the state determination unit 213 (S203). The state determination unit 213 determines the open/close state of the door based on the detection data “open” (S205), and generates the determination result “door open.” The communication unit 215 transmits the determination result “door open” and the identification information IDa to the environmental sound reproducing device 230 (S207).

The environmental sound selection unit 233 selects the environmental sound data “wooden door open” from the environmental sound database 231 based on the combination of the determination result “door open” and the identification information IDa (S209), and supplies it to the environmental sound reproducing unit 235 (S211). The environmental sound reproducing unit 235 (re)produces a sound represented by the environmental sound data “wooden door open” (S213), and outputs the resulting sound that best expresses the open state of the wooden door to the outside (i.e., system user).

When the steel door, that is the determination target Ob, is closed, the second sensor unit 211b detects the close state of the steel door (S221), and supplies the detection data “close” which indicates the close state of the door and the identification information IDb of the second sensor unit 211b to the state determination unit 213 (S223). The state determination unit 213 determines the open/close state of the steel door based on the detection data “close” (S225), and generates the determination result “door close.” The communication unit 215 transmits the determination result “door close” and the identification information IDb to the environmental sound reproducing device 230 (S227).

The environmental sound selection unit 233 selects the environmental sound data “steel door close” from the environmental sound database 231 based on the determination result “door close” and the identification information IDb (S229), and supplies it to the environmental sound reproducing unit 235 (S231). The environmental sound reproducing unit 235 reproduces a sound represented by the environmental sound data “steel door close” (S233), and outputs the resulting sound to the outside (or the system user). Thus, the open/close states of the wooden door and the steel door, that are the detection targets Oa and Ob, can be appropriately transferred to the user of the environmental sound reproducing system 200.

As described above, the detection device 210 of the environmental sound reproducing system 200 of the second embodiment obtains the state information that indicates the states of two or more detection targets Oa, Ob, . . . respectively and the identification information IDa, IDb, . . . that identify the detection targets Oa, Ob, . . . , and the environmental sound reproducing device 230 selects and reproduces the environmental sound data corresponding to the state of one of the detection targets Oa, Ob, . . . . Therefore, the states of two or more detection targets Oa, Ob, . . . can be appropriately transferred to the system user using the single environmental sound reproducing device 230.

### 4. Third Embodiment

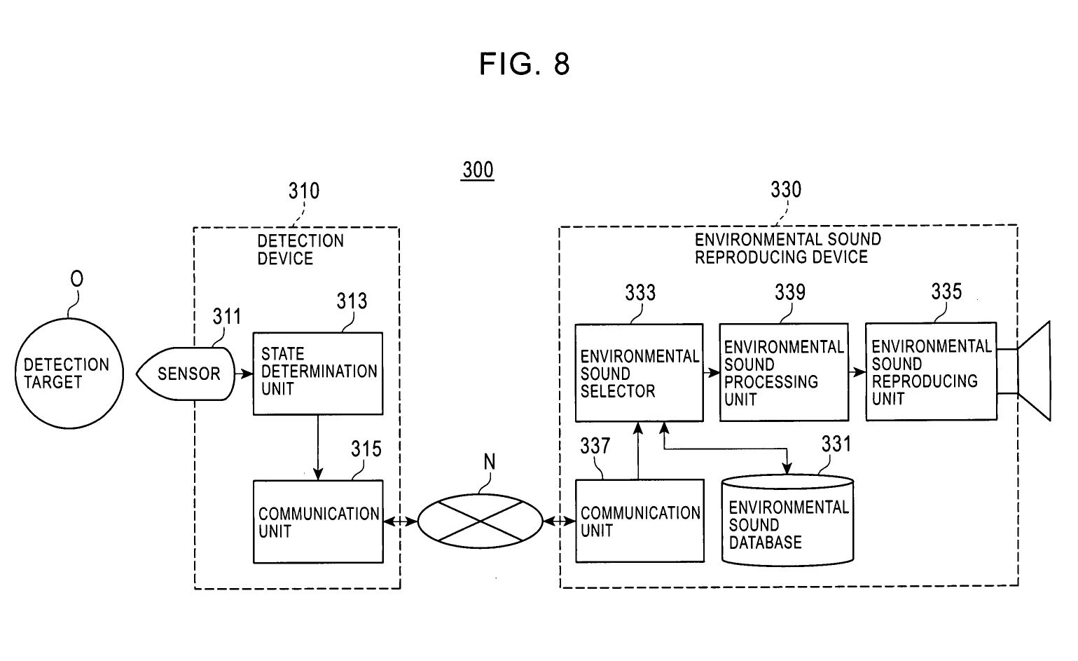

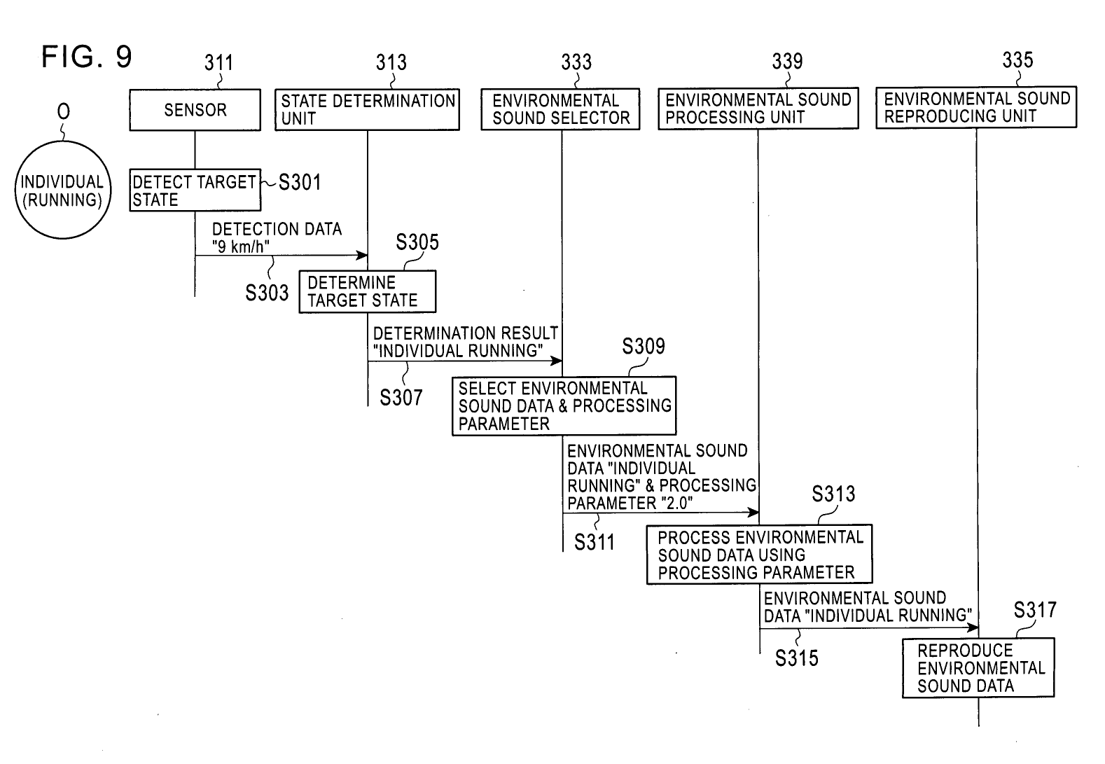

An environmental sound reproducing system 300 according to a third embodiment of the present invention will now be described with reference to FIG. 8 and FIG. 9. The third embodiment has similar aspects and features to the first embodiment, and therefore redundant description mutual to both the embodiments is omitted in the following description.

It should be recalled that the environmental sound reproducing system 100 according to the first embodiment is designed to reproduce environmental sound (data) which is prepared in advance. Various environmental sound data is prepared to best express (or correspond to) various predicted states of the detection target respectively. Hence in the case of generating the determination results “individual walking slowly,” “individual walking,” “individual walking quickly” and “individual running” according to four predicted moving states of an individual, for example, four environmental sound data must be prepared. The environmental sound reproducing system 300 according to the third embodiment is designed to appropriately transfer various states of the detection target O using a small(er) quantity of environmental sound data.

### 4.1 Functional Configuration of Environmental Sound Reproducing System 300

FIG. 8 is a block diagram depicting a functional configuration of the environmental sound reproducing system 300 according to the third embodiment. As FIG. 8 shows, the environmental sound reproducing system 300 has an environmental sound reproducing device 330 that includes an environmental sound processing unit 339. A case of reproducing environmental sound data corresponding to the moving state of an individual is described as an example.

A sensor unit 311 is a moving speed sensor that detects the moving state of an individual using a position detection system. The sensor unit 311 supplies detection data “0 km/h,” “4 km/h,” “6 km/h” or the like to indicate the moving state (moving speed) of an individual, to a state determination unit 313.

The state determination unit 313 generates the determination result “individual stopping,” “individual walking slowly,” “individual walking,” “individual walking quickly” or “individual running” based on the detection data. The state of the detection target O is decided by comparing the detection data supplied from the sensor 311 with the determination conditions managed by the state determination unit 313. In this embodiment, the determination conditions are conditions for determining “individual stopping” when the detection data is “less than 2 km/h,” “individual walking slowly” when the detection data is “between 2 km/h and 4 km/h,” “individual walking” when the detection data is “between 4 km/h and 6 km/h,” “individual walking quickly” when the detection data is “between 6 km/h and 8 km/h,” and “individual running” when the detection data is “over 8 km/h.”

An environmental sound database 331 stores environmental sound data “individual walking” and the processing parameters. The environmental sound data “individual walking” is sound data that corresponds to the moving state of walking at “between 4 km/h and 6 km/h.” The processing parameters are set corresponding to respective moving states of the individual. In this embodiment, the processing parameters are “0.0,” “0.5,” “1.0,” “1.5,” and “2.0” corresponding to the determination results “individual stopping,” “individual walking slowly,” “individual walking,” “individual walking quickly” and “individual running.” The environmental sound data “individual walking” is used as reference sound data, and the processing parameter “1.0” is used for the reference sound data.

If the determination result “individual walking” is received, for example, an environmental sound selection unit 333 selects the reference environmental sound data “individual walking” and the processing parameter 1.0 for the determination result “individual walking.” If the determination result “individual running” is received, the environmental sound selection unit 333 selects the reference environmental sound data “individual walking” and the processing parameter 2.0 for the determination result “individual running.” The environmental sound selection unit 333 supplies the reference environmental sound data and the selected processing parameter to the environmental sound processing unit 339. It should be noted that if the reference environmental sound data need not be processed, such as a case of receiving the determination result “individual walking,” for example, the environmental sound selection unit 333 may not supply the reference environmental sound data to the environmental sound processing unit 339, but may supply it to the environment sound reproducing unit 335.

The environmental sound processing unit 339 processes the reference environmental sound data using the selected processing parameter. For example, the environmental sound processing unit 339 processes the reference environmental sound data “individual walking” to the environmental sound data “individual running” of which the reproducing speed is double, using the processing parameter “2.0.” The environmental sound processing unit 339 supplies the processed environmental sound data, such as the environmental sound data “individual running,” to the environmental sound reproducing unit 335. The reference environmental sound data may be processed by changing the volume of sound reproduced, changing the quality of the sound reproduced, or the like, instead of changing the reproducing speed.

### 4.2 Operation of Environmental Sound Reproducing System 300

FIG. 9 is a sequence diagram depicting an operation of the environmental sound reproducing system 300 according to the third embodiment.

As FIG. 9 shows, when the detection target O is an individual and the individual moving at 9 km/h is detected. The moving speed sensor 311 detects the moving state of the individual (S301), and supplies the detection data “9 km/h” that indicates the moving state of the individual to the state determination unit 313 (S303). The state determination unit 313 determines the moving state of the individual based on the detection data “9 km/h” (S305), and generates the determination result “individual running.” The communication unit 315 transmits the determination result “individual running” to the environmental sound reproducing device 330 (S307).

The environmental sound selector 333 selects the reference environmental sound data “individual walking” and the processing parameter “2.0” from the environmental sound database 331 based on the determination result “individual running” (S309), and supplies them to the environmental sound processing unit 339 (S311). The environmental sound processing unit 339 processes the reference environmental sound data “individual walking” into the environmental sound data “individual running” of which reproducing speed is double based on the processing parameter (S313), and supplies it to the environmental sound reproducing unit 335 (S315). The environmental sound reproducing unit 335 reproduces a sound represented by the processed environmental sound data “individual running” (S317), and outputs the resulting sound (environmental sound) that indicates the running state of the individual to the outside (system user). Thus, the various moving states of the individual, that is the detection target O, can be appropriately transferred to the user of the environmental sound reproducing system 300 using the single environmental sound data (reference sound data).

As described above, the environmental sound reproducing system 300 of the third embodiment reproduces (creates) the environmental sound data, that is obtained by processing the reference environmental sound data with a selected parameter (or by processing the reference environmental sound data) in a manner to correspond to the state of the detection target O. Therefore, the various states of the detection target O can be appropriately transferred using a small volume of reference environmental sound data.

### 5. Fourth Embodiment

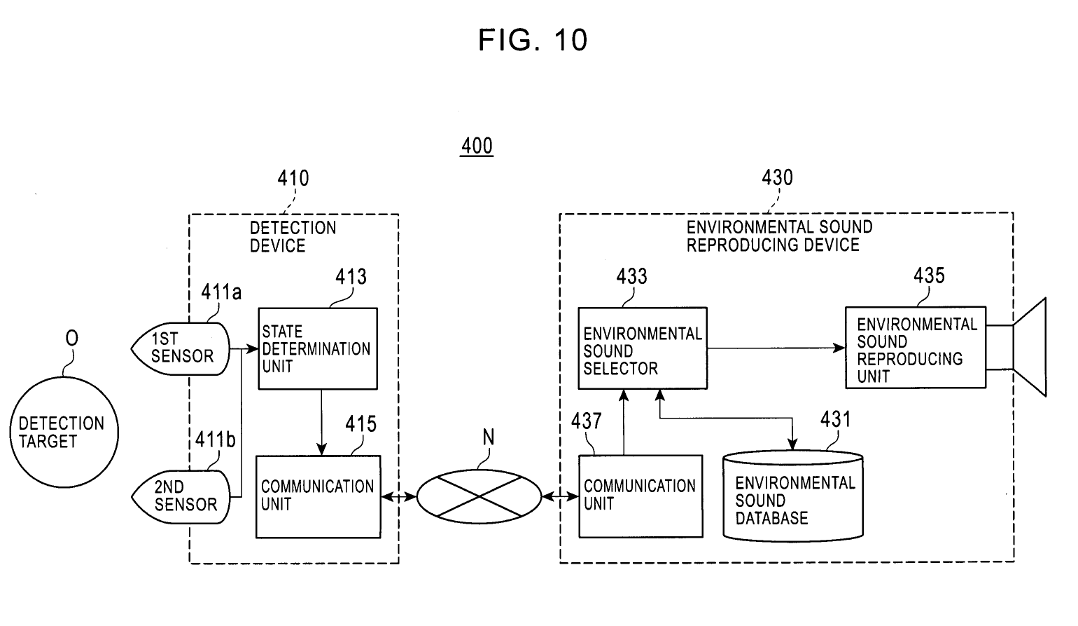

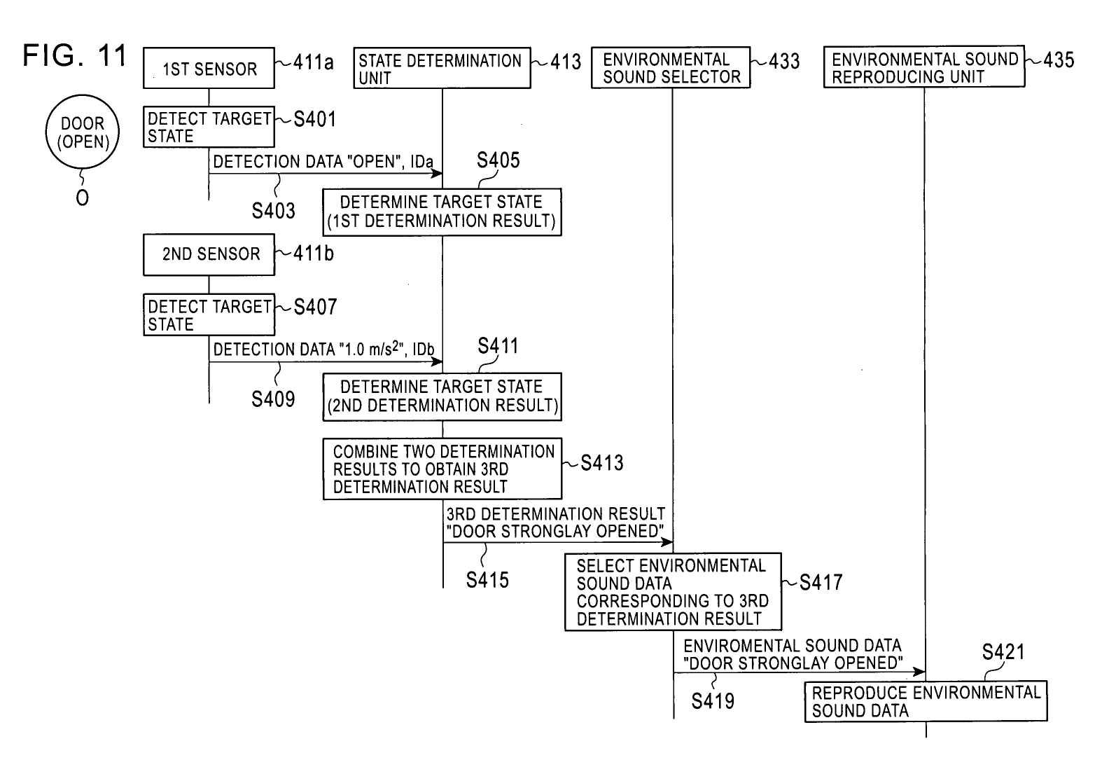

An environmental sound reproducing system 400 according to a fourth embodiment of the present invention will now be described with reference to FIG. 10 and FIG. 11. The fourth embodiment has similar aspects and features to the first embodiment, and therefore redundant description mutual to both the embodiments is omitted in the following description.

As described in the foregoing with reference to FIG. 2 to FIG. 5, the environmental sound reproducing system 100 according to the first embodiment is designed to transfer to the system user the state of the detection target O using single state information. The state information is either detection data or determination result derived from the detection data. The case of using the determination result for state information is described below. The environmental sound reproducing system 100 of the first embodiment cannot transfer a system user the detailed state of the detection target O, such as the strength (speed) of opening/closing the door. More specifically, the first embodiment does not use two or more state determination results of the detection target O, such as the determination result of the open/close state of the door, and the determination result of the moving state (speed or acceleration) of the opening/closing of the door. The environmental sound reproducing system 400 according to the fourth embodiment transfers a detailed state of the detection target O based on the combination of the two or more state determination results.

### 5.1 Functional Configuration of the Environmental Sound Reproducing System 400

FIG. 10 is a block diagram depicting a functional configuration example of the environmental sound reproducing system 400 according to the fourth embodiment. As FIG. 10 shows, the environmental sound reproducing system 400 has a detection device 410 that includes two sensor units 411a, 411b, and an environmental sound reproducing device 430. A case of reproducing environmental sound data corresponding to the open/close state of a door considering the acceleration of the opening/closing door will be described below. The number of sensor units be three or more, and three or more sensor units 411 (411a, 411b, . . . ) may detect three or more types of states on the same detection target O.

The two sensor units 411a and 411b detect two types of states of the same detection target O respectively. The first sensor unit 411a is assigned identification information IDa. The first sensor unit 411a is a door open/close sensor that detects the open/close state of the door. The second sensor unit 411b is assigned identification information IDb. The second sensor unit 411b is an acceleration sensor that detects the moving state (acceleration applied to the door when opening/closing) of the door. The first sensor unit 411a supplies first detection data “open” or “close” that indicates the open/close state of the door, along with the identification information IDa of the first sensor unit 411a, to a state determination unit 413. The second sensor unit 411b supplies second detection data that indicates the moving state (acceleration) of the door, such as “0.5 m/s²” or “1.0 m/s²,” along with the identification information IDb of the second sensor unit 411b to the state determination unit 413.

The state determination unit 413 determines the detailed state of the detection target O based on the two detection data. The state determination unit 413 generates a first determination result “door open” or “door close” based on the first detection data “open” or “close.” The state determination unit 413 uses a threshold “less than 0.5 m/s²” for the second detection data. The state determination unit 413 generates a second determination result “acceleration low” or “acceleration high” based on whether the second detection data is “less than 0.5 m/s²” or “0.5 m/s² or more.” The state determination unit 413 combines the first and second determination results to generate the third or final determination result. If the first and second determination results are “door open” and “acceleration low,” for example, then the state determination unit 413 generates the final determination result “door opened gently.” If the first and second determination results are “door close” and “acceleration high,” the state determination unit 413 generates the final determination result “door closed strongly.”

An environmental sound database 431 stores the environmental sound data “door opened gently,” “door opened strongly,” “door closed gently” and “door closed strongly,” in association with the open/close states and moving states of the door. The sound data “door opened gently” is prepared in advance to represent the gentle opening movement of the door. The sound data “door opened strongly,” “door closed gently” and “door closed strongly” are also prepared in advance to represent respective movements of the door.

If the determination result “door opened gently” is received, for example, an environmental sound selector 433 selects the environmental sound data “door opened gently.” If the determination result “door closed strongly” is received, the environmental sound selection unit 433 selects the environmental sound data “door closed strongly.”

It should be noted that the environmental sound reproducing device 430 may include the environmental sound processing unit 339 according to the third embodiment. Then, the detection device 410 may send the first and second determination results to the environmental sound reproducing device 430, and the environmental sound reproducing device 430 may process and reproduce the environmental sound data based on the first and second determination results. In this case, the environmental sound processing unit 339 creates the environmental sound data “door opened strongly,” of which reproducing speed and reproducing sound volume are 1.5 times the reference environmental sound data, from the reference environmental sound data “door open” which is provided in advance, based on the first and second determination results “door open” and “acceleration high.”

### 5.2 Operation of Environmental Sound Reproducing System 400

FIG. 11 is a sequence diagram depicting an operation of the environmental sound reproducing system 400 according to the fourth embodiment.

As FIG. 11 shows, when the door that is the detection target O is opened, the first sensor unit 411a detects the open state of the door (S401), and supplies the first detection data “open” that indicates the open state of the door and the identification information IDa of the first sensor unit 411a to the state determination unit 413 (S403). The state determination unit 413 determines the open/close state of the door based on the first detection data “open” and the identification information IDa (S405), and generates the first determination result “door open.” In the meanwhile, the second sensor unit 411b detects the moving state of the door (S407), and supplies the second detection data “1.0 m/s²” that indicates the moving state of the door and the identification information IDb of the second sensor unit 411b to the state determination unit 413

(S409). The state determination unit 413 determines the moving state of the door based on the second detection data “1.0 m/s²” and the second sensor identification information IDb (S411), and generates the second determination result “acceleration high.” The state determination unit 413 combines the first and second determination results to generate the third determination result (or combined determination result) “door opened strongly” (S413). The communication unit 415 transmits the third determination result “door opened strongly” to the environmental sound reproducing device 430 (S415).

The environmental sound selection unit 433 selects the environmental sound data “door opened strongly” from the environmental sound database 431 based on the determination result “door opened strongly” (S417), and supplies the environmental sound data “door opened strongly” to an environmental sound reproducing unit 435 (S419). The environmental sound reproducing unit 435 reproduces the environmental sound data “door opened strongly” (i.e., creates a sound represented by the environmental sound data “door opened strongly”) (S421), and outputs the environmental sound that corresponds to the state of the door opened strongly to the outside (to the system user). Therefore, a most accurate or detailed open/close state of the door, that is the detection target O, can be transferred to the user of the environmental sound reproducing system 400 based on the combination of two types of detection data.

As described above, the environmental sound reproducing system 400 of the fourth embodiment detects plural types of actual states of the same detection target O, and selects and reproduces the single environmental sound data corresponding to the detected states of the detection target O. Consequently, the detailed state of the detection target O can be reproduced and provided to the system user based on the combination of more than one type of state information.

### 6. Fifth Embodiment

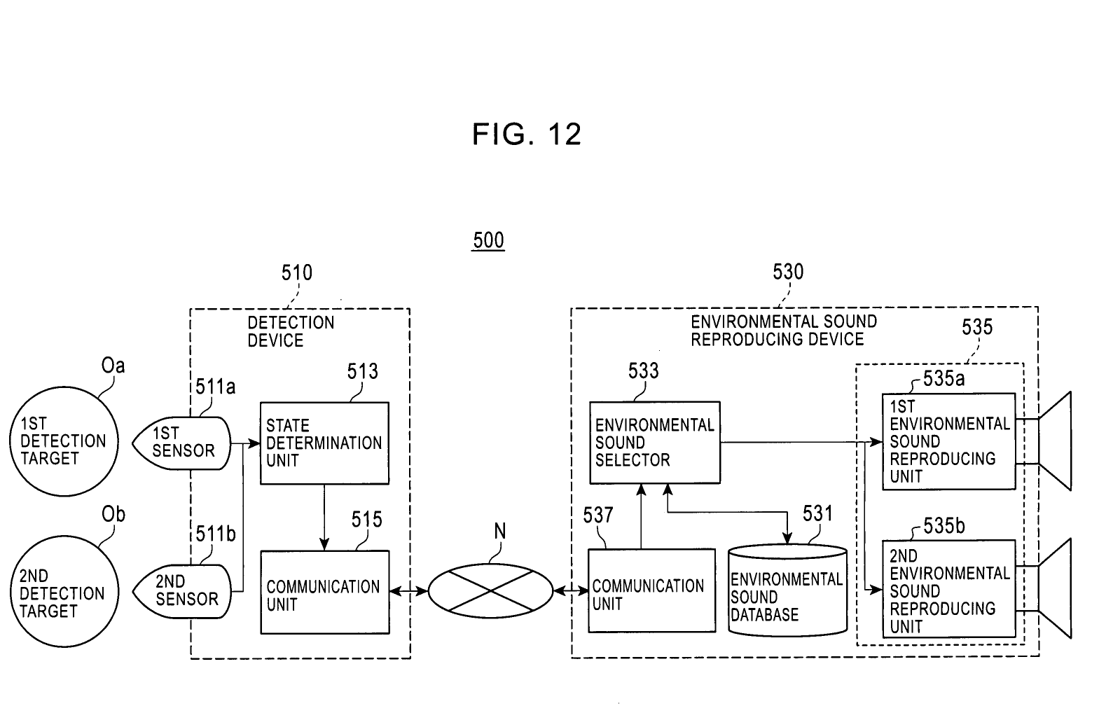

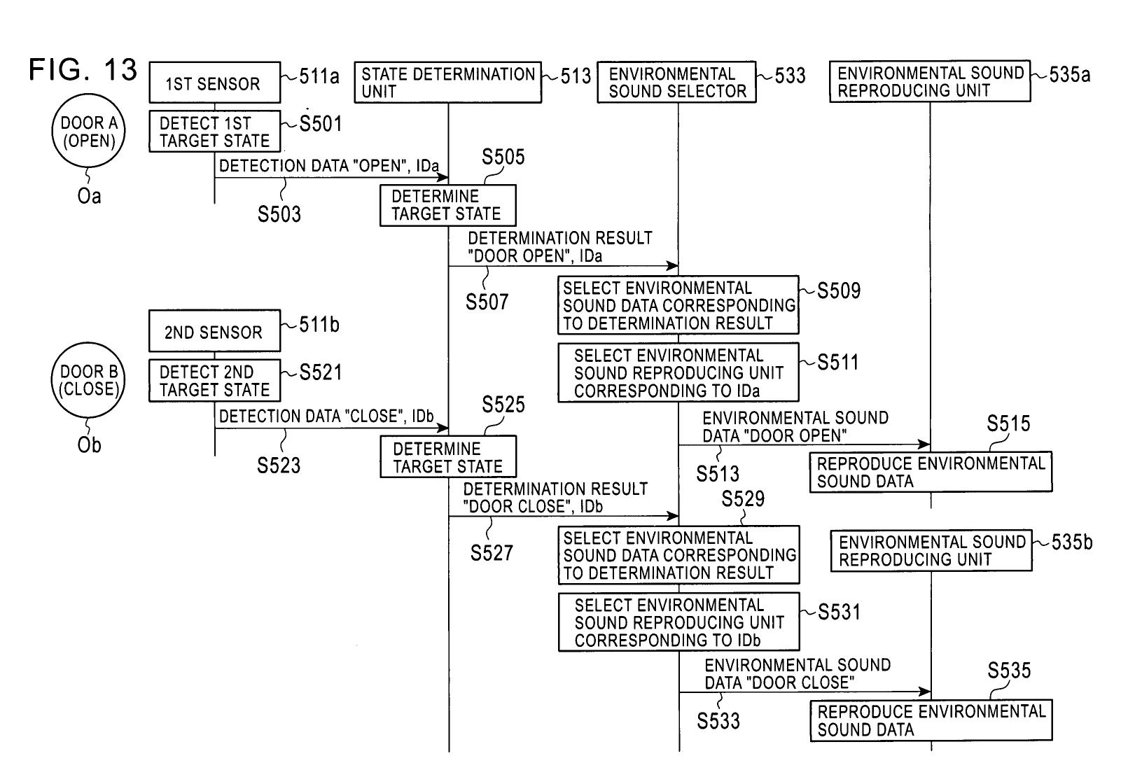

An environmental sound reproducing system 500 according to a fifth embodiment of the present invention will now be described with reference to FIG. 12 and FIG. 13. The fifth embodiment has similar aspects and features to the first and second embodiments, and therefore redundant description mutual to these embodiments is omitted in the following description.

As described earlier with reference to FIG. 6 and FIG. 7, the environmental sound reproducing system 200 of the second embodiment is adapted to transfer a system user one of the two states of two detection targets Oa and Ob using the single environmental sound reproducing unit 235. Accordingly, the second embodiment cannot transfer a system user two or more states of two or more detection targets Oa and Ob . . . simultaneously. The environmental sound reproducing system 500 according to the fifth embodiment is designed to transfer a plurality of states of a plurality of detection targets Oa, Ob, . . . using a plurality of environmental sound reproducing units. These environmental sound reproducing units are provided in a single environmental sound generation device 530 (FIG. 12).

### 6.1 Functional Configuration of the Environmental Sound Reproducing System 500

FIG. 12 is a block diagram depicting a functional configuration of the environmental sound reproducing system 500 according to the fifth embodiment. As FIG. 12 shows, the environmental sound reproducing system 500 has a detection device 510 that includes two sensor units 511a and 511b, and an environmental sound reproducing device 530 that includes two environmental sound reproducing units 535a and 535b. A case of reproducing environmental sound data corresponding to the open/close states of doors A and B is described in this embodiment. It should be noted that the number of environmental sound reproducing units 535a, 535b, . . . may be three or more.

The sensor units 511a and 511b, to which identification information IDa and IDb are assigned respectively, are the door open/close sensors that detect the open/close states of door A and door B respectively. The sensor units 511a and 511b supply the detection data “open” or “close” that indicates the open/close states of the door A and door B, along with the respective identification information IDa and IDb, to the state determination unit 513. The identification information is information to identify not only the sensor unit 511a/511b but also the associated environmental sound reproducing unit 535a/535b.

The state determination unit 513 generates the of determination result “door open” or “door close” based on the detection data “open” or “close” that indicates the open/close state of the door concerned. Thus, the state determination unit 513 generates two determination results for the two doors A and B.

A communication unit 515 sends the determination results together with the identification information of the sensor units 511a and 511b to the environmental sound reproducing device 530.

An environmental sound database 531 has already stored the environmental sound data “door open” and “door close” in association with the open state and close state of each door.

When the determination result “door open” or “door close” and the identification information are received, the environmental sound selection unit 533 selects the environmental sound data “door open” or “door close” based on the determination result and identification information. This selection is carried out for each of the two doors A and B. Then the environmental sound selection unit 533 supplies the selected environmental sound data to the environmental sound reproducing units 535a and 535b, based on the identification information. If the determination result “door open” and the identification information IDa are received, for example, the environmental sound selection unit 533 supplies the environmental sound data “door open” to the environmental sound reproducing unit 535a. If the determination result “door close” and the identification information IDb are received, the environmental sound selection unit 533 supplies the environmental sound data “door close” to the environmental sound reproducing unit 535b. It should be noted that when the door A is only opened (or closed) and the door B is still (i.e., remains at its starting or original position), then the determination result for the door A is only sent to the environmental sound selection unit 533. Likewise, when the door B is only opened (or closed) and the door A is still, the determination result for the door B is only sent to the environmental sound selection unit 533.

The environmental sound reproducing unit 535 has the environmental sound reproducing units 535a and 535b, which are associated with the sensor units 511a and 511b respectively. The environmental sound reproducing units 535a and 535b reproduce the environmental sound data that is supplied from the environmental sound selection unit 533, and outputs an environmental sound corresponding to the environmental sound data to the outside. The environmental sound reproducing unit 535a reproduces the environmental sound data corresponding to the detection data of the sensor unit 511a, and the environmental sound reproducing unit 535b reproduces the environmental sound data corresponding to the detection data of the sensor unit 511b. The environmental sound reproducing units 535a and 535b may not be disposed corresponding to the number of sensor units 511a and 511b. For example, a single environmental sound reproducing unit having the function to reproduce the environmental sound may be disposed, and two environmental sound output means (e.g., two speakers) may be disposed corresponding to the two sensor units 511a, 511b and may be connected to the single environmental sound reproducing unit by wire or wireless via a suitable communication device or technology.

### 6.2 Operation of Environmental Sound Reproducing System 500

FIG. 13 is a sequence diagram depicting an operation of the environmental sound reproducing system 500 according to the fifth embodiment.

As FIG. 13 shows, if the first door A, that is the detection target Oa, is opened, the first sensor unit 511a detects the open state of the first door A (S501), and supplies the detection data “open” that indicates the open state of the door A and the identification information IDa of the first sensor unit 511a to the state determination unit 513 (S503). The state determination unit 513 determines the open/close state of door A based on the detection data “open” and the identification information IDa (S505), and generates the determination result “door open.” The communication unit 515 transmits the determination result “door open” and the identification information IDa to the environmental sound reproducing device 530 (S507).

The environmental sound selection unit 533 selects the environmental sound data “door open” from the environmental sound database 531 based on the determination result “door open” (S509). The environmental sound selection unit 533 selects the environmental sound reproducing unit 535a as the environmental sound data supply destination based on the identification information IDa (S511), and supplies the environmental sound data “door open” to the environmental sound reproducing unit 535a (S513). The environmental sound reproducing unit 535a reproduces the environmental sound data “door open” (produces a sound represented by the environmental sound data “door open”) (S515), and outputs the environmental sound to the outside (system user).

If the second door B, that is the second detection target Ob, is closed, the second sensor unit 511b detects the close state of the door B (S521), and supplies the detection data “close” that indicates the close state of door B and the identification information IDb of the second sensor unit 511b to the state determination unit 513 (S523). The state determination unit 513 determines the open/close state of door B based on the detection data “close” and the identification information IDb (S525), and generates the determination result “door close.” The communication unit 515 transmits the determination result “door close” and the identification information IDb to the environmental sound reproducing device 530 (S527).

The environmental sound selection unit 533 selects the environmental sound data “door close” from the environmental sound database 531 based on the determination result “door close” (S529). The environmental sound selection unit 533 then selects the environmental sound reproducing unit 535b as the environmental sound data supply destination based on the identification information IDb (S531), and supplies the environmental sound data “door close” to the environmental sound reproducing unit 535b (S533). The environmental sound reproducing unit 535b reproduces the environmental sound data “door close” (creates a sound represented by the environmental sound data “door close”) (S535), and outputs the environmental sound to the outside. Thus, the states of two detection targets Oa and Ob can be appropriately transferred to the user of the environmental sound reproducing system 500 using the single environmental sound reproducing device 530.

As described above, the environmental sound reproducing system 500 of the fifth embodiment detects each state of the two or more detection targets Oa, Ob, . . . , and selects and reproduces the environmental sound data corresponding to the state of each detection target Oa, Ob, . . . . The states of two or more detection targets Oa, Ob, . . . are transferred to the system user by the single environmental sound regeneration device 530.

### 7. Hardware Configuration of Environmental Sound Reproducing Device

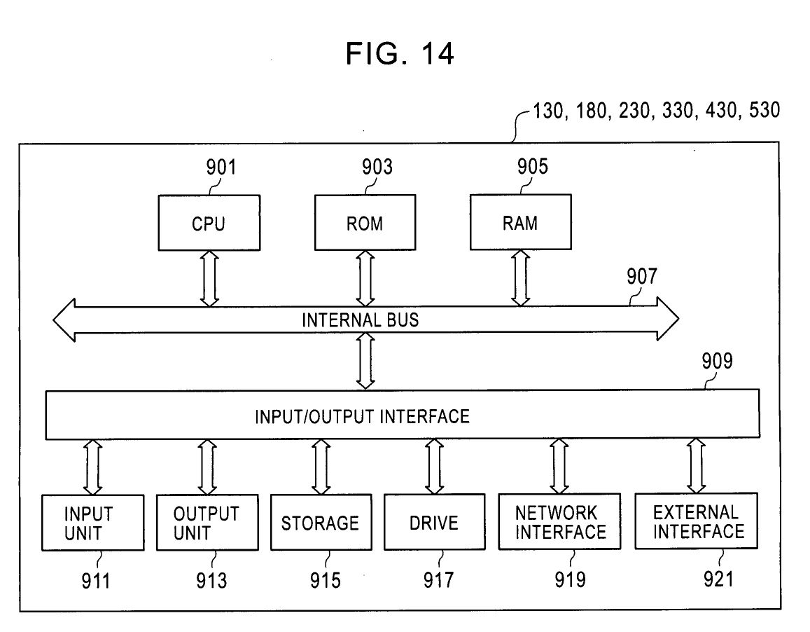

The hardware configuration of the environmental sound reproducing device 130, 180, 230, 330, 430 or 530 according to the embodiments of the present invention will now be described with reference to FIG. 14. FIG. 14 is a block diagram depicting an example of the hardware configuration of the environmental sound reproducing device 130, 180, 230, 330, 430 or 530.

The environmental sound reproducing device 130, 180, 230, 330, 430 or 530 includes a CPU 901, ROM 903, RAM 905, internal bus 907, input/output interface 909, input unit 911, output unit 913, storage 915, drive 917, network interface 919 and external interface 921.

The CPU 901 functions as a processor and control device, and controls some or all of the operations of the environmental sound reproducing device 130, 180, 230, 330, 430, 530 according to various programs recorded in ROM 903, RAM 905, storage 915 and/or removal storage media. The ROM 903 stores programs and parameters used by the CPU 901. The RAM 905 temporarily stores programs that the CPU 901 executes as well as parameters that the CPU 901 uses when executing the programs. The CPU 901, ROM 903 and RAM 905 are interconnected via the internal bus 907. The internal bus 907 is connected to the input/output interface 909.

The input unit 911 is an operation means that the user can operate, such as a mouse, keyboard, touch panel, buttons, or switches, or any suitable combination thereof. The input unit 911 includes an input control circuit that generates an input signal based on the operation information that the user enters using the operation means, and supplies the input signal to the CPU 901. The user of the environmental sound reproducing device 130, 180, 230, 330, 430 or 530 inputs various data to the environmental sound reproducing device 130, 180, 230, 330, 430 or 530 by using the input unit 911 in order to instruct the processing and operation.

The output unit 913 includes a device that can auditorally notify the acquired information to the user, such as a sound output device including a speaker, headphone and earphone. The output unit 913 outputs the processing result of the environmental sound reproducing device 130, 180, 230, 330, 430 or 530. For example, the sound output device may convert such audio signals as reproduced sound or voice data and acoustic data into analog signals (i.e., sound), and outputs them.

The storage 915 is a device for storing data, including a magnetic storage device, such as HDD, semiconductor storage device, optical storage device and magneto-optical storage device. The storage 915 may store the environmental sound database (15, 131, 183, . . . or 531), programs executed by the CPU 901, various data, and data acquired from the outside.

The drive 917 is a reader/writer for recording media, and is built (or integrated) in or externally connected to the environmental sound reproducing device 130, 180, 230, 330, 430 or 530. The drive 917 reads the recorded data from the removable recording media, such as a magnetic disk, optical disk, magneto-optical disk or semiconductor memory, and outputs it to RAM 905, or writes the detection or recording target data to the removable recording media.

The network interface 919 includes a communication device to connect to the communication network N. The network interface 919 is, for example, a cable or radio LAN, communication card for WUSB, router for ADSL, or communication modem. The network interface 919 transmits/receives signals to/from the Internat or other communication equipment according to a predetermined protocol. The communication network N (FIG. 2) that is connected to the network interface 919 is a cable or radio network, e.g., the Internet, home LAN, infrared network, radio wave communication network and satellite communication network.

The external interface 921 is a port to directly connect external equipment to the environmental sound reproducing device 130, 180, 230, 330, 430 or 530, such as USB port, SCSI port and RS232C port. The environmental sound reproducing device 130, 180, 230, 330, 430 or 530 acquires/sends data from/to the external equipment connected to the external interface 921 via the external interface 921.

An example of a hardware configuration to implement the functions of the environmental sound reproducing device 130, 180, 230, 330, 430 or 530 according to the embodiments of the present invention was described. Each composing element of the hardware may be constituted by a standard device, or by a special device dedicated to the function of that composing element. Also, all or part of the functions of the environmental sound reproducing device 130, 180, 230, 330, 430, 530 may be implemented by software or combination of software and hardware.

It should be noted that the present invention is not limited to the above-described embodiments. It is obvious to those skilled in the art that various changes and modifications may be made without departing from the spirit and scope of the present invention, and the scope of the present invention should be determined by the appended claims.

The environmental sound reproducing system 100, 200, 300, 400 and 500 according to the first to fifth embodiments were described focusing on the functional characteristics of each embodiment. It should be noted that the states of two or more detection targets Oa, Ob, . . . may be transferred, for example, by the two or more environmental sound reproducing units each corresponding to each detection target Oa, Ob, . . . using a single environmental sound reproducing device. This modification may be realized by a combination of the functional characteristics of the second and fifth embodiments.

This application is based on Japanese Patent Application No. 2009-82750 filed on Mar. 30, 2009 and the entire disclosure thereof is incorporated herein by reference.

What is claimed is:

1. An environmental sound reproducing device, comprising:
a reception unit that receives state information indicating a state of a detection target from an external detection device;
an environmental sound storage that stores one or more environmental sound data;
an environmental sound selector that selects, based on the state information received from the detection device, one of the environmental sound data from the environmental sound storage; and
an environmental sound reproducing unit that reproduces the selected one of the environmental sound data.

2. The environmental sound reproducing device according to claim 1, wherein the external detection device can detect a plurality of states of a plurality of detection targets respectively, and the reception unit receives state information indicating the state of each detection target and identification information identifying the detection target concerned, from the external detection device, and
the environmental sound selector selects, based on a combination of the state information and the identification information received from the detection device, one of the environmental sound data the environmental sound storage.

3. The environmental sound reproducing device according to claim 1, wherein reference environmental sound data corresponding to a predetermined state of the detection target is the only environmental data stored in the environmental sound storage, and the environmental sound selector always selects the reference environmental sound data,
the environmental sound reproducing device further includes an environmental sound processing unit that processes the selected reference environmental sound data into sound data corresponding to the state of the detection target received from the detection device, based on the state information received from the detection device, and
the environmental sound reproducing unit reproduces the sound data processed by the environmental sound processing unit.

4. The environmental sound reproducing device according to claim 1, wherein the external detection device can detect two or more types of states of the detection target, and the reception unit receives state information indicating two or more types of states of the detection target from the external detection device, and
the environmental sound selector selects one of the environmental sound data from the environmental sound storage based on the state information received from the detection device.

5. The environmental sound reproducing device according to claim 1, wherein the external detection device is adapted to detect a plurality of states of a plurality of detection targets respectively, and the reception unit receives state information indicating the state of each detection target from the external detection device,
the environmental sound reproducing unit has a plurality of sound reproducing modules that correspond to the plurality of detection targets respectively,
the environmental sound selector selects one of the environmental sound data corresponding to the state of each of the detection targets from the environmental sound storage based on each of the state information received from the detection device, and
each of the plurality of sound reproducing modules of the environmental sound reproducing unit reproduces the selected environmental sound data for the associated detection target.

6. The environmental sound reproducing device according to claim 5, wherein the plurality of sound reproducing modules reproduce a plurality of the environmental sound data simultaneously if the reception unit receives the state information indicating a plurality of states of the detection targets.

7. The environmental sound reproducing device according to claim 1, wherein the external detection device is a detector or sensor associated with the target, and the state information is a detection data of the detector or sensor.

8. The environmental sound reproducing device according to claim 1, wherein the external detection device includes a detector or sensor associated with the target, and also includes a determination unit for generating a determination result regarding a state of the target based on a detection data of the detector or sensor, and the state information is the determination result generated by the determination unit.

9. The environmental sound reproducing device according to claim 7 further comprising a determination unit for generating a determination result regarding a state of the target based on the detection data of the detector or sensor, wherein the environmental sound selector selects the one environmental sound data based on the determination result generated by the determination unit.

10. The environmental sound reproducing device according to claim 1, wherein the external detection device detects plural types of states of the detection target, and prepares single state information from the plural types of states by giving a priority to one of the detected states of the detection target under a predetermined condition,
the reception unit receives the single state information from the external detection device, and
the environmental sound selector selects one of the environmental sound data from the environmental sound storage based on the state information received from the detection device.

11. An environmental sound reproducing system, comprising:
a detection device for detecting a state of a detection target to generate state information indicating the detected state of the detection target; and
an environmental sound reproducing device of claim 1, wherein the environmental sound reproducing device receives the state information from the detection device.

12. An environmental sound reproducing system, comprising:
a detection device for detecting a plurality of states of a plurality of detection targets and generating a single information indicating one of the detected states of the plurality of detection targets; and
an environmental sound reproducing device of claim 2, wherein the environmental sound reproducing device receives the state information from the detection device.

13. An environmental sound reproducing system, comprising:
a detection device for detecting a state of a detection target to generate state information indicating the detected state of the detection target; and
an environmental sound reproducing device of claim 3, wherein the environmental sound reproducing device receives the state information from the detection device.

14. An environmental sound reproducing system, comprising:
a detection device for detecting a plurality of states of a detection target to generate state information indicating one or more of the detected plurality of states of the detection target; and
an environmental sound reproducing device of claim 4, wherein the environmental sound reproducing device receives the state information from the detection device.

15. An environmental sound reproducing system, comprising:
a detection device for detecting a plurality of states of a plurality of detection targets to generate a plurality of state information indicating the detected plurality of states of the detection targets; and
an environmental sound reproducing device of claim 5, wherein the environmental sound reproducing device receives the state information from the detection device.

16. An environmental sound reproducing method for use with an environmental sound reproducing device of claim 1, said method comprising:
receiving state information indicating a state of a detection target from an external detection device;
selecting, based on the state information received from the detection device, one of already prepared environmental sound data; and
reproducing the selected environmental sound data.

17. A program for causing a computer to execute an environmental sound reproducing method of claim 16.
